(19) United States
(12) Patent Application Publication
(10) Pub. No.: US 2026/0144280 A1
(43) Pub. Date: May 28, 2026

(54) ENZYME-MODIFIED EGG YOLK PRODUCTS

(71) Applicant: MICHAEL FOODS, INC., Hopkins, MN (US)

(72) Inventor: Siquan LI, Hopkins, MN (US)

(21) Appl. No.: 19/445,234

(22) Filed: Jan. 9, 2026

Related U.S. Application Data
(63) Continuation of application No. 17/846,032, filed on Jun. 22, 2022.
Application No. 17/846,032 is a continuation of application No. PCT/US2022/012837, filed on Jan. 19, 2022.
(60) Provisional application No. 63/139,773, filed on Jan. 20, 2021.

(51) Int. Cl. A23L 15/00; A23L 27/60

(52) U.S. Cl. CPC A23L 15/25; A23L 27/60; A23V 2002/00

(57) ABSTRACT

An enzyme-modified egg yolk product that can be provided in liquid or powder form can be used to make a mayonnaise having a low viscosity, e.g., no more than 3500 cP, and exhibiting good stability at temperatures of greater than 90° C. (e.g., 200° F.).

### CROSS-REFERENCE TO RELATED APPLICATIONS

This application is a continuation application of U.S. patent application Ser. No. 17/846,032, filed Jun. 22, 2022, which is a continuation of International Application PCT/US2022/12837 filed Jan. 19, 2022, which claims priority to U.S. Provisional Patent Application No. 63/139,773 filed Jan. 20, 2021, all of which are incorporated herein by reference in their entireties.

### BACKGROUND INFORMATION

Eggs are used as and in a variety of food ingredients and products. Egg ingredients for production traditionally have been in the form of whole (shell) eggs, but advances in science and engineering technology have brought about numerous alternatives including liquid and dried or powder egg products, which are able to be treated with enzymes to improve their functionality and use.

Egg yolk is a complex oil-water emulsion of ˜50% water, ˜32% lipids and ˜16% protein. Approximately 28% of the lipids are phospholipids, which are useful in the manufacture of enzyme-modified egg yolk and finished goods manufactured therefrom. About three-fourths of the phospholipids in egg yolk are phosphatidylcholine, with the remaining phospholipids being, in descending order of prevalence, phosphatidylethanolamine, lysophosphatidylcholine, sphingomyelin, lysophosphatidylethanolamine, plasmalogen and inositol phospholipid.

Egg yolk powders typically contain ˜60% lipids, including phospholipids and lysophospholipids. The protein profile in egg yolk includes ˜68% low density lipoprotein (lipo-vitellin), 12% high density lipoprotein, 12% livetins, and 7% phosvitin. The majority of egg yolk proteins and lipids/phospholipids form lipoprotein complexes and micelles.

In foods, emulsifier(s) often is/are part of a complex matrix which can contain other molecules, both surface active and not. Factors such as ionic strength and pH can significantly impact the activity of the emulsifier.

In the United States, 21 C.F.R § 169.140 requires that mayonnaise must contain not less than 65% (w w) vegetable oil, at least 2.5% (w w) acetic or citric acid, and some manner of egg yolk. Certain optional ingredients (e.g., salt, sugar, etc.) are permitted.

Egg yolk acts as a natural emulsifier between the oil and water phases, providing excellent emulsification by reducing the surface energy between polar and non-polar components. Due to the presence of various lipid and protein types in egg yolk, it has useful emulsifying and gelation properties, which makes it useful in recipes for products such as mayonnaise. Egg yolk contains surface active components which contain both hydrophobic and hydrophilic domains. These surface active components are able to stabilize an emulsion by forming an interfacial layer around the emulsion droplets and providing kinetic stability of the emulsion.

Mayonnaises made with currently available enzyme-modified yolk products typically have viscosities in the range of from 4200 to 4800 cP. Those made with plain yolks (i.e., yolks which have not undergone enzymatic hydrolysis) often have viscosities of from 3400 to 3700 cP.

Many such mayonnaises do not possess good heat stability and tend to “oil off,” break down, or separate. Commercially available enzyme-modified egg yolk products, of the type used to make mayonnaise products in the first viscosity range noted above, provide desired heat stability at temperatures of at least ˜90° C., particularly in the range of ˜93° to ˜99° C. (200° to 210° F.). Conversely, mayonnaise products made with plain (non-modified) egg yolk exhibit emulsion stability problems at lower temperatures, e.g., 70° to 80° C. (158° to 176° F.).

To enhance mayonnaise emulsions, properties such as fat droplet size, surface area, surface tension, and viscosity often are areas of focus. Viscosity modifiers can negatively impact emulsion stability by causing depletion flocculation. Controlling degree of hydrolysis of egg yolk phospholipids in the aforementioned enzyme-modified egg yolk products has been an area of ongoing research.

An enzyme-modified egg yolk product that can be used to provide a mayonnaise having a viscosity more akin to that of an unmodified yolk, or even lower, but with good emulsion stability at elevated temperatures, particularly at or above ˜93° C., remains desirable. Such a mayonnaise that is easier to pump during processing, easier to package, and pourable or more easily squeezed during application is particularly desirable. Ideally, ability to exhibit organoleptic properties such as creaminess and full mouthfeel would not be negatively impacted.

### SUMMARY

Food processors, including but not limited to mayonnaise producers, have a demand for an enzyme-modified yolk product, either dried or liquid, to enable them to make low viscosity (≤3500 cP) products which exhibit good stability at elevated temperatures (≥93° C.). Such products can find particular utility in connection with containers designed to be squeezed. They also can provide significant benefits to product handling and cleanability.

Provided herein is an enzyme-modified egg yolk powder that can be used to provide a heat stable, low viscosity mayonnaise. The viscosity of the mayonnaise product is similar to, or even less than, one made from an otherwise identical recipe but using unmodified egg yolks. No chemical additives or ingredients are required in the product's manufacture, providing a clean formula and label for the mayonnaise.

Also disclosed are processes providing both an enzyme-modified egg yolk and mayonnaise products incorporating it.

In one aspect is provided a process for providing a modified egg yolk product. To pasteurized liquid egg yolk is added an aqueous solution of a generally regarded as safe (GRAS) food grade base so as to provide a caustic intermediate having a pH of 8±0.25. To the inter-mediate is added an enzymatic liquid, with the temperature of the resulting mixture being held at from ˜46° to ˜52° C. (115° to 125° F.) for a time of from ˜300 to ˜450 minutes. Optionally, the process also can include pasteurizing the modified egg yolk product and/or spray drying it so as to yield a powder version of the modified egg yolk product.

The foregoing process results in a hydrolyzed egg yolk product which, when used to make a mayonnaise product, results in a product having a lower viscosity than those resulting from use of other enzyme-modified egg yolk products and similar to or even less than unmodified egg yolk products. Further, the end product has heat stability performance characteristics similar to, or even essentially the same as, those made from other enzyme-modified egg yolk products and far better than those resulting from use of unmodified egg yolk products.

In addition to controlling the degree of hydrolysis of phospholipids (reflected as percent free fatty acids in the enzyme-modified yolk), the present modified egg yolk product takes into account functionality and thermal alteration of proteins as well interactions between yolk proteins and yolk lipids. Enhanced entanglement between proteins and yolk lipids, particularly phospholipids, is believed to involve enhanced hydrophobic interactions between hydrophobic sites of the lipids and protein molecules. Without intending to be bound by theory, exposure of yolk proteins to high temperatures alters their stereo structures (3-dimensional con-figurations) and increases the exposure of their hydrophobic sites to their surroundings, allowing them to more readily combine with the hydrophobic regions of yolk lipids and phospholipids, with larger complexes resulting from this enhanced yolk protein-lipid/phospholipid entanglement. This enhanced entanglement reduces volumetric sizes of these yolk complexes which can decrease the final viscosity of a mayonnaise into which they are incorporated, while improving the yolk's emulsification capacity and stability.

As suggested by the foregoing, the functionality of the present modified egg yolk products differ from those of both unmodified and conventional enzyme-modified yolk products.

These modified egg yolk products advantageously have improved emulsifying properties in the egg yolk itself, as well as an ability to stabilize otherwise incompatible ingredients.

In yet another aspect is provided a mayonnaise that includes a hydrolyzed egg yolk product which is heat stable to at least 93° C. (200° F.) and has a viscosity at 20° C. of no more than ˜3700 cP, preferably no more than 3500 cP, when measured at a shear speed of 160 rpm after 300 seconds of elapsed time. At elevated temperatures (e.g., 93° C. or higher), little to no oil-off or emulsion breakage or cooking burns are evident. Further, salt, sugar, or other chemical additives need not be added to the mayonnaise product.

The provided modified egg yolk products feature enhanced functionality in emulsion applications, resulting in valuable savings, a cleaner label and less ingredient handling. If desired, these enzyme-modified egg products may be dried, frozen and refrigerated and can be used in baking applications, dressings and sauce formulations.

The term “viscosity” herein throughout refers to dynamic viscosity (u), an indication of a fluid's resistance to flow, which is the tangential force per unit area necessary to move one plane past another at unit velocity at unit distance apart. It is. Its SI physical unit is the Pascal-second (Pa·s), which is identical to I kg/m·s. The physical unit for dynamic viscosity in the centimeter gram second (cgs) system of units is the poise (P), more commonly expressed, particularly in ASTM standards, as centipoise (cP).

The following description is presented to enable a skilled artisan to make and use one or more embodiments of the inventive aspects. The general principles described herein may be applied to embodiments and applications other than those detailed below without departing from the spirit and scope of the disclosure. Therefore, the embodiments which follow are not exclusive but, instead, representative and are to be accorded the widest scope consistent with the principles and features disclosed or suggested herein.

Throughout this document, unless the surrounding text explicitly indicates a contrary intention, all values given in the form of percentages are w/w, pH values are those which can be obtained from any of a variety of potentiometric techniques employing a properly calibrated electrode, and recited numerical limitations include an appropriate degree of precision based on the number of significant places used; for example, “up to 5.0” can be read as setting a lower absolute ceiling than “up to 5.”

### BRIEF DESCRIPTION OF THE DRAWINGS

FIG. 1 is a plot of viscosity versus time for both pasteurized-but-unmodified (plain) yolk and an enzyme-modified yolk product.

FIGS. 2A and 2B are differential scanning calorimetry (DSC) plots for, respectively, plain dried egg yolk powder and an enzyme-modified yolk product powder.

FIG. 3 is a plot of mayonnaise viscosities against time for unmodified (plain) yolk and enzyme-modified yolk product powders.

### DESCRIPTION OF ILLUSTRATIVE EMBODIMENTS

Described here are enzyme-modified egg yolk products and methods for making the same. Modified egg yolks can be provided through the action of a food grade quality and regulatorily approved enzyme, which improves the emulsification properties by modifying yolk phospholipids. The enzymes may or may not be kosher and halal approved and certified and can be from different origins (e.g., animal and microbial).

Exemplary enzymes include Phospholipase A1 (PLA1) and A2 (PLA2), with the latter being preferred due to its ability to provide higher stability products. PLA2 is specifically designed for food applications, serving to catalyze hydrolysis of the fatty acid in the second position of phospholipids or lecithin. PLA2 splits the fatty acid in position two of phospholipids, hydrolyzing the bond between the second fatty acid “tail” and the glycerol backbone. It is specific for the sn-2 acyl bond of phospholipids and catalytically hydrolyzes phospholipids exclusively at the 2-position, giving rise to the formation of 1-acyl-3-sn-lysophospholipids and free fatty acids.

During enzymatic modification of egg yolks, phospholipids are converted into stable lysophospholipids (“LPLs”). Non-limiting examples of LPLs include lysophosphatidylcholine, lysophosphatidylethanolamine and lysophosphatidaylserine lysophosphatidic acid (radyl-lyso-glycerophosphate, LPA), 2,3-cyclic phosphatidic acid, 1-alkyl-2-acetyl-glycero-3-phosphate, sphingosine-1-phosphate (SIP), dihydro-sphingosine-1-phosphate, sphingosylphosphorylcholine (lysosphingomyelin, SPC), and lysophosphatidylcholine (LPC). Conversion of phospholipids to LPLs results in hydrolysis of the egg yolk.

LPLs provide enhanced emulsification relative to their phospholipid precursors due to increased hydrophilicity and molecular flexibility. They also tend to be more stable at or when exposed to elevated temperatures, e.g., greater than ˜90° C.

Enzymatic (PLA2) treatment of egg yolk before spray drying improves its surface activity and solubility. Without such treatment, the egg yolk loses interfacial activity and gel properties due to a heat-induced denaturation and solidification.

When an enzyme-modified (hydrolyzed) egg yolk is spray dried, most moisture is removed. The PLA2 reaction adds hydrolytic phosphatide generation of lysophosphatide, and lysophosphatide provides advantages in molecular flexibility and high temperature resistance upon rehydration. The enzyme-modified egg yolk, after spray drying, provides high quality egg yolk powder having increased solubility, dispersibility, and flowability.

LPLs generated from the enzymatic modification inhibit breakage of emulsions (either oil-in-water or water-in-oil), which causes oil(s) to separate, flocculate, and form large clusters at elevated temperatures (e.g., ˜93° C.). This provides much desired heat stability to products such as, particularly, mayonnaise, permitting use in a broader range of applications and enhanced flexibility, for example, high temperature pasteurization/retort to improve microbiological safety and product shelf life.

A process for making an enzyme-modified egg yolk product according to the present invention now is described.

Raw liquid egg yolk from a commercial egg breaking line having a solids content of ˜44%+5% typically is employed as the starting material.

Pasteurizing the liquid egg yolk provides both needed microbiological safety and the desired pre-treatment of egg yolk proteins and lecithin so as to facilitate the later PLA enzyme modification process and enhanced interactions between proteins and LPLs. Pasteurization preferably is done at a temperature in the range of 60° to ˜66° C. (140° to 150° F.), more preferably ˜61° to ˜65° C. (142° to 149° F.), and most preferably of ˜62° to ˜64° C. (144° to 148° F.). The time at which the egg yolk is maintained at elevated temperature depends in large part on the particular temperature(s) chosen. Often, the amount of time ranges from 200 to 600, commonly from 225 to 500 seconds, and typically from 250 to 400 seconds. Ordinarily skilled artisans can select a time that is appropriate given the particular temperature or temperatures involved with a given batch of egg yolks.

Yolk pH is adjusted to close to 8.0, usually 8±0.25, commonly 8±0.2, typically 8 ±0.15, and preferably 8±0.1. (These pH values are those obtained from measurements at a temperature similar to those set forth in the preceding paragraph.) This can be accomplished with an aqueous solution of a GRAS base (e.g., NaOH or KOH) at a concentration (w w) of ˜1 to ˜30%, preferably ˜4 to ˜15%, more preferably ˜4 to ˜7.5%, and most preferably ˜4 to ˜5%. The caustic solution is added with appropriate agitation/mixing to avoid localized pH shock.

To this pH-adjusted yolk is added enzyme. The enzyme can be obtained in liquid or dry form. If the latter is to be used, it should be dissolved in an excess of purified (e.g., deionized or distilled) water, e.g., at a ratio of from 1:2 to 1:10, of from 1:3 to 1:9, of from 1:4 to 1:8, or from 1:5 to 1:7.

Liquid enzyme (or enzyme solution) is added to the pH-adjusted yolk, with sufficient agitation to permit dispersion throughout the entirety of the container in which the pH-adjusted yolk is held. During mixing, addition or incorporation of air to the yolk preferably is minimized.

Relative to the amount of pH-adjusted egg yolk, the weight percentage of enzyme ranges from 0.0225 to 0.0275%, preferably from 0.023 to 0.027%, and more preferably from 0.024 to 0.026%.

The enzyme is permitted to catalyze the desired hydrolysis at a temperature of from ˜43° to ˜54° C. (110° to 130° F.), generally of from 46° to 52° C. (˜1 15° F. to ˜125° F.), commonly of from 47° to 50.5° C. (˜117° to ˜123° F.), and preferably of from 48° to 50° C. (˜119° to ˜122° F.). The length of the permitted reaction can depend on the temperature(s) employed but, at the foregoing temperatures, exemplary ranges are −250 to −500 minutes, commonly 265 to 475 minutes, typically 280 to 450 minutes, more typically 300 to 425 minutes, and most typically 330 to 410 minutes.

During the enzymatic reaction, monitoring of the yolk pH and free fatty acid concentration can help to determine the degree of hydrolysis, which can vary somewhat based on the desired product functionality. In the industry, a common way to indicate degree of hydrolysis is by measuring the amount of oleic acid, an abundant and important unsaturated fatty acid with well documented nutritional significance. Fatty acids liberated through the enzymatically induced hydrolysis are converted to oleic acid, and the amount of that acid is measured.

Untreated yolk usually has a free fatty acid (in equivalent oleic acid) content of from ˜0.7% to ˜1.8% (w w), varying based on breed, feed, and growth conditions. With the modified egg yolk product, prior to final (full) pasteurization, the weight percent of (equivalent) oleic acid present generally is in the range of from −6.5 to −12%, commonly from ˜7 to ˜10%, and typically from ˜7.5 to ˜9.5%; other exemplary ranges include ˜6.7 to ˜11.5%, ˜6.8 to ˜11%, ˜6.9 to ˜10.5%, ˜7.2 to ˜9.8%, or ˜7.3 to ˜9.7%. (The amount of oleic acid in the powder form does not differ significantly from the amount measured in the liquid form.)

The pH of the enzyme-modified egg yolk (without neutralization, measured at about ˜49° to ˜51° C. (120° to 124° F.)) generally ranges from 6.2 to 7.0, commonly 6.3 to 6.8, and typically 6.4 to 6.6.

The viscosity of the liquid enzyme-modified egg yolk is significantly higher than that of untreated egg yolk, which tends to be 300-1000 cP on initial production date. Enzyme-modified liquid yolk usually exhibits a viscosity that is 3.5 to >13 times higher than that of untreated yolk, i.e., 3800±250 cP, commonly 3750±100 cP, when measured on Brookfield LV viscometer (Model DV-II+Pro) at 30 rpm, #63 spindle, and 300 seconds elapsed time. Without intending to be bound by theory, this enhanced viscosity might be due to enhanced interactions and entanglements between the highly flexible LPL molecules and more rigid and enlarged yolk protein micelles.

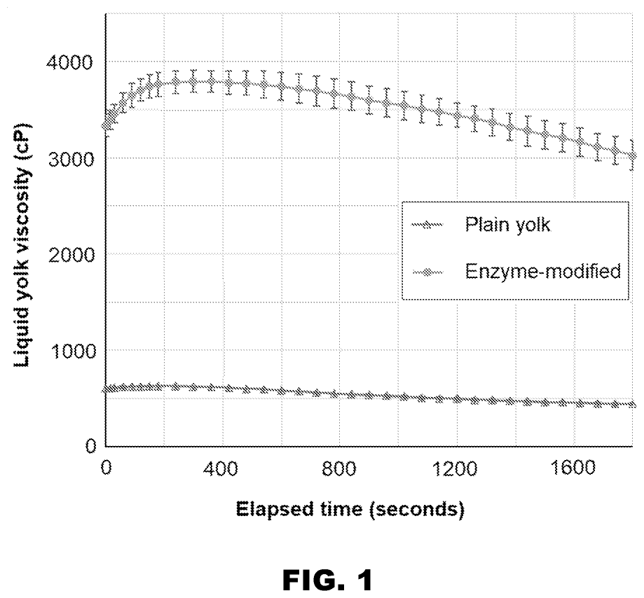

A comparison of viscosities of a pasteurized-but-unmodified (plain) yolk and an enzyme-modified yolk product is presented in FIG. 1. The results reported were means and standard deviations from three test repetitions (sample temperature of 4-5° C. at reading). Enzyme-modified yolk retains the pseudoplastic rheological properties of plain yolk, with viscosity rising during the first phase of shearing before decreasing after reaching a peak value (3792±113 cP for the enzyme-modified yolk product versus 621±5 cP for plain yolk).

The enzyme-modified (hydrolyzed) egg yolk preferably is pasteurized by being held at a temperature of from 66° to 72° C. (˜152° to ˜162° F.), from 67° to 72° C. (˜153° to˜161° F.), or from 68° to 71° C. (˜155° to ˜160° F.), with cycling or alternating temperatures also being possible. The length of time at which the hydrolyzed egg yolk is held at elevated temperature depends on the particular temperature(s) used but generally ranges from 150 to 500 seconds, commonly from ˜200 to ˜480 seconds, typically from ˜225 to ˜475 seconds, more typically from ˜250 to ˜470 seconds, and most often from ˜275 to ˜465 seconds. An exemplary time-temperature combination is 69° to 70.5° C. (˜156° to ˜159° F.) for 330 to 400 seconds.

Regardless of whether pasteurized, the modified egg yolk is cooled below 5° C. or, preferably, 4.5° C. (40° F.).

The cooled product can be stored at refrigerator or freezer temperatures if it is to be used in liquid form.

Alternatively, for a shelf-stable product (which is convenient for shipping, handling, and customer incorporation into products such as mayonnaise), the liquid can be spray dried so as to provide a powder form. The spray drying of liquid egg yolk products is sufficiently well known that it does not require description here.

In addition to the aforementioned difference in free fatty acid weight percentages, the powder form of enzyme-modified egg yolks provided from the foregoing process have DSC characteristics distinct from those of plain yolk powder and previously available modified egg yolk powders.

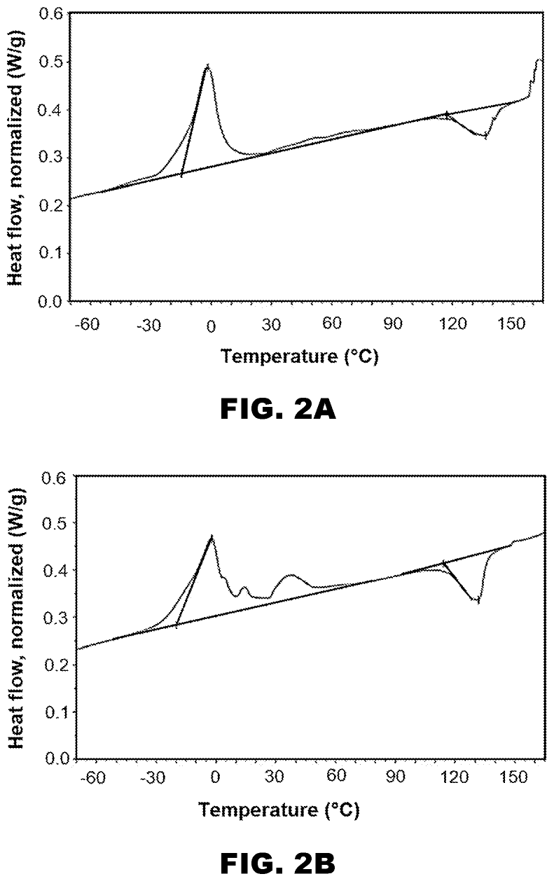

Thermographs of powdered enzyme-modified egg yolk products according to the present invention typically show significant left shifts for both endothermic and exothermic peaks. This can be seen by comparing the DSC curves provided as FIGS. 2A and 2B, some key data of which is tabulated below, with all temperatures being provided in ° C. and enthalpies in J/g.

TABLE 1
DSC data

| | Endothermic peak, <30° C. | | | Exothermic peak, >100° C. | | |
|---|---|---|---|---|---|---|
| | Onset T | Peak T | Enthalpy | Onset T | Peak T | Enthalpy |
| plain yolk (FIG. 2A) | −14.7 | −1.8 | 23.73 | 117.2 | 136.5 | 6.01 |
| modified yolk (FIG. 2B) | −19.9 | −2.2 | 27.50 | 114.0 | 131.7 | 8.65 |

The endothermic peak (representing melting behaviors when sample temperature is ramped from below melting point of bound water) of the enzyme-modified egg yolk product has an onset temperature point left shifted ˜5° C. relative to plain yolk. This substantial shift indicates a significantly lower melting point of the water (melting at a lower temperature), which further indicates significantly stronger bonds between moisture and its binding sites including protein side chain hydrophilic groups such as lysine's m-amino group, serine's hydroxyl group and glutamic acid and aspartic acid's carboxyl groups. The ˜4 J/g increase in enthalpy indicates significantly more energy is released from this phase transition process due to stronger moisture binding, in turn suggesting significantly more water binding sites and binding of water.

The exothermic peak left shifted ˜5° C. relative to that of plain yolk, suggesting that the proteinaceous mass in the enzyme-modified yolk product starts its glass transition at a lower temperature than does plain yolk powder but requires a significantly higher energy input to drive this phase transition process, again indicating entangling of proteins, both with other protein molecules and with other compounds in the matrix such as phospholipids, LPLs, triglycerides, and di- and monoglycerides was in more complicated formats. This transition's enthalpy increase of ˜2.5 J/g indicates much more energy is needed to activate this phase transition, suggesting a much higher resistance to phase transition. This too is consistent with entanglements between proteins and other compounds in the enzyme-modified yolk products being more complicated, yielding a more temperature-sensitive (early onset temperature) but more orderly (higher transition enthalpy) system. It further suggests that the proteinaceous-lipid entanglement within the enzyme-modified yolk product powder is less flexible, having a higher degree of internal entanglement among yolk proteins, meaning they are less available for interaction with (including entanglements) other components (i.e., food ingredients) when formulated into a product like mayonnaise. This is believed to be a key factor in being able to provide a lower viscosity to products in which such modified yolk products are incorporated.

The enzyme-modified egg yolk, regardless of physical form, can be used to provide stable emulsions, and maintain them once formed. Fat droplet sizes are reduced to optimal levels, with or without the assistance of chemical emulsifier(s). Egg yolk proteins and their derivatives, particularly ones with appropriate polarities and sizes, coat the surfaces of the fat droplets and disperse in the continuous phase of the emulsion between droplets. While these proteins perform the necessary functions of preventing dispersed fat droplets from coalescing, they also impact viscosity, spreadability and mouthfeel of a product like mayonnaise. Current practices have focused on controlling degree of hydrolysis of phospholipids (reflected as percent free fatty acids in the enzyme-modified yolk) but not on process impacts on yolk protein functionalities and their interactions with yolk lipids and phospholipids, with alterations to those yolk proteins significantly impacting properties of a food product into which such yolk products are incorporated, e.g., mayonnaise, particularly the product viscosity.

The processing of the enzyme-modified egg yolk product discussed above can provide to mayonnaise products made therewith a lower-than-expected viscosity, which is determined largely by the properties of soluble egg yolk proteins and yolk protein/phospholipid complexes dispersed in the continuous phase. This is done through intentional alteration of yolk protein denaturation, yolk protein-lipid interactions, and solubility of these proteins and their derivatives.

By controlling these factors, one can provide low viscosity mayonnaise which still exhibits good stability and elevated temperatures. This can be done without changing the ingredients or ratios employed in the mayonnaise recipe. By way of exemplification only, a common amount of egg yolk employed in the manufacture of mayonnaise often is on the order of 2.8 to 3.2% (w w) of powder or 6.5 to 6.7% (w w) liquid.

Mayonnaise products made with the presently provided modified egg yolk products, even without otherwise changing existing recipes, can exhibit viscosities of no more than 3500 cP, no more than 3400 cP, no more than 3300 cP, and even no more than 3250 cP. (A manner for determining viscosity is provided below.) In terms of ranges, such mayonnaise products typically have viscosities of from 2900 to ˜3800 cP, from 3000 to 3700 cP, from 3100 to 3600 cP, from 3150 to 3500 cP, from 3200 to 3450 cP, and from 3250 to 3425 cP. This provides manufacturers an opportunity, without otherwise changing their recipes, to produce a heat stable (at a temperature higher than ˜93° C. (200° F.)) product which has the same or even lower viscosity. Mayonnaises made with plain yolk powders are not heat stable and have broken emulsion with oil-off when warmed up to temperatures much lower than 93° C. (200° F.).

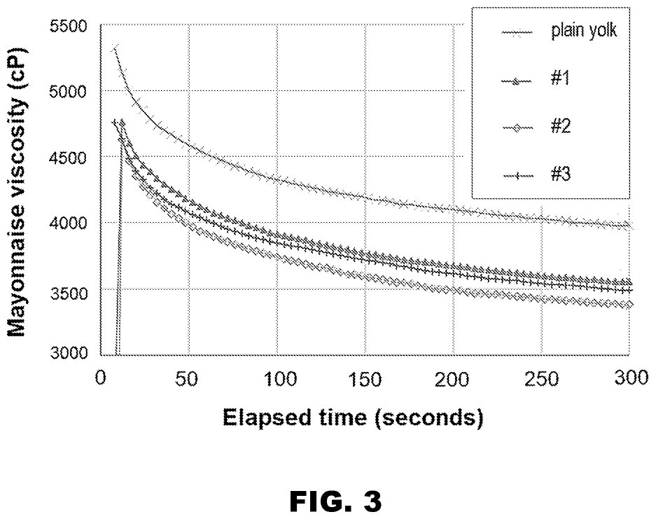

FIG. 3 shows a plot of viscosity against time for four mayonnaises made using the same ingredients and processing conditions. The weight percentage of each ingredient used in this recipe was as follows:
vegetable oil: 65.0%
egg yolk powder: 3.0%
xanthan gum: 0.1%
sugar: 3.0%
salt: 1.3%
water: 21.6%
5% vinegar solution: 6.0%.
   One mayonnaise employed a plain yolk powder while three (designated #1, #2 and #3) used a modified yolk powder according to the present invention.

The data show mayonnaise products incorporating enzyme-modified yolk product powders according to the present invention having reductions in viscosity of ˜425 to ˜590 cP from that of a mayonnaise incorporating a plain yolk powder (˜3980 cP). Measurements were made using a Rapid Visco Analyzer, model 4500, at 20° C. and 160 rpm.

Many mayonnaises made with modified yolk powders according the present invention also can be poured at room temperature, a characteristic that cannot be achieved with plain yolk powders.

These and other mayonnaise products, additionally or alternatively, exhibit excellent emulsion stabilities at ˜93° C. (200° F.), ˜99° C. (210° F.), ˜104° C. (220° F.), or even higher. When measuring heat stability for the mayonnaise product, the mayonnaise is typically held for at least 10 seconds or longer at a temperature of ≥90° C. (e.g., 200° F.) to see whether the mayonnaise holds stable without any oil-off, breakdown, or separation. This can be accomplished on a 50 g mayonnaise sample in a glass bowl by heating in a 2250 watt microwave oven for 10 seconds twice with an interval or no more than 2 seconds; this heating regimen typically raises that size mayonnaise sample to a temperature of >90° C. (˜200° F.). A mayonnaise that holds stable without any oil-off, breakdown, or separation is considered to be heat stable.

Heat stability data for a mayonnaise made from the enzyme-modified egg yolk powder and for a mayonnaise made from plain egg yolk powder are tabulated below.

TABLE 2
mayonnaise heat stability evaluation

| | Temperature (° C.) | | Oil | Emulsion | |
|---|---|---|---|---|---|
| | 10 sec × 2 | 10 sec × 3 | separation | breakage | Burns? |
| plain yolk | 94.3 | — | Severe | Complete | Yes |
| modified yolk | 99.3 | 110.6 | No | No | No |

Heat stability is an important attribute, especially for retail sandwich manufacturing and mayonnaise manufacturers. Mayonnaise without this desired heat stability is usable in cold application such as refrigerated sandwiches or freshly built, made-to-order sandwiches, which in many cases do not require reheat. However, if a non-heat stable mayonnaise is used in retail applications where heat is a factor, the mayonnaise will exhibit oil separation (oil-off) due to emulsion breakdown, resulting in poor texture with undesired mouthfeel and taste. Mayonnaise with a broken emulsion exhibits separated oil and coats the tongue surface, causing poor mouth-feel, along with potential oil drops which stain clothing. Non-emulsified, free oil also interrupts sandwich taste by showing its source taste, such as beany notes for soy oil, particularly an aftertaste which reduces consumer satisfaction.

Emulsion breakage caused by using mayonnaises made with plain yolk also can be observed when mayonnaise applied to even fresh built sandwiches that happen to include grilled or cooked patties or meat components at a high temperature, i.e., ≥80° C. (˜175° F.). For food safety, heating meat components to a minimum of 71° C. (160° F.) is required although, in practice, much higher temperatures are reached so as to minimize risks resulting from heat process variations and product non-uniformity.

For retail sandwiches that require heat (or where heat is factor), and even where a reheating to a safe temperature is necessary (e.g., frozen sandwiches), a heat stable mayonnaise during heating or reheat will have limited, to no, oil-off, breakdown, or separation. The finished good has little-to-no mess, good texture, mouthfeel and taste in the end finished good.

Additionally, manufacturers of bottled mayonnaise now can make products which can undergo pasteurization or even retort to provide, without the use of preservatives or chemical additives, desired microbiological safety and a significantly longer shelf life. Mayonnaise made with plain or currently available modified egg yolks cannot sustain the high temperatures employed in these processes, and instead rely on lower pH (and/or, in some cases, preservatives) to curb microorganism growth. Further, the same existing mayonnaise products are difficult to pump through process lines due to high viscosities. Conversely, a mayonnaise made with a described enzyme-modified yolk product has lower viscosity while, at the same time, improved heat stability.

Use of the present enzyme-modified egg yolk product results in a very clean recipe with only egg yolk and phospholipase, along with necessary alkaline as processing aids for pH adjustment, in the ingredient statement. This enables mayonnaise manufacturers to bear clean label claims and help consumers avoid unnecessary exposure to chemical additives.

The following embodiments are specifically contemplated.

Embodiment [1] relates to a process for providing a hydrolyzed egg yolk product, with the process including adding a sufficient amount of an aqueous solution of a GRAS base to pasteurized egg yolk so as to provide a caustic yolk having a pH of from about 7.8 to about 8.2, (b) adding to said caustic yolk from 0.0225 to 0.0275%, based on the amount of caustic yolk, of an enzymatic liquid and (c) holding the resulting mixture at a temperature of from 43° to 54° C. for 300 to 450 minutes, thereby providing a hydrolyzed egg yolk product.

Embodiment [2] relates to the process of embodiment [1] further comprising pasteurizing said hydrolyzed egg yolk product at a temperature of from about 68° to about 71° C.

Embodiment [3] relates to the process of any of embodiments [1] to [2] further comprising cooling said hydrolyzed egg yolk to a temperature of less than about 5° C.

Embodiment [4] relates to the process of any of embodiments [1] to [3] further comprising spray drying said hydrolyzed egg yolk so as to provide a modified egg yolk powder.

Embodiment [5] relates to the process of any one of embodiments [1] to [4] wherein said caustic yolk has a pH from about 7.9 to about 8.1.

Embodiment [6] relates to the process of any one of embodiments [1] to [5] wherein, in step (c), said resulting mixture is held at a temperature of from ˜48° to 50° C. for a time of from about 360 to about 390 minutes.

Embodiment [7] relates to a hydrolyzed liquid egg yolk comprising from about 6.5 to about 12% (w w) oleic acid.

Embodiment [8] relates to the hydrolyzed liquid egg yolk of embodiment [7] comprising at least 7% (w w) oleic acid.

Embodiment [9] relates to the hydrolyzed liquid egg yolk of embodiment [8] comprising from 7.5% to 9.5% (w w) oleic acid.

Embodiment relates to the hydrolyzed liquid egg yolk of any one of embodiments [7] to [9] wherein the pH of said egg yolk, measured at from 120° to 124° F., is from 6.3 to 7.0.

Embodiment relates to a modified egg yolk powder provided from the hydrolyzed liquid egg yolk of any of embodiments [7] to [10].

Embodiment relates to a mayonnaise comprising a hydrolyzed egg yolk product, said mayonnaise being heat stable up to at least 200° F. and having a dynamic viscosity at 20° C. of from about 2900 to about 3800 cP when measured at or after 100 seconds and a shear speed of 160 rpm.

Embodiment relates to the mayonnaise of embodiment wherein said viscosity is measured at or after 300 seconds.

Embodiment relates to the mayonnaise of any of embodiments to having a dynamic viscosity of no more than 3500 cP.

1-20. (canceled)

21. A process for providing a hydrolyzed egg yolk product, comprising
(a) adding an aqueous solution of a generally regarded as safe (GRAS) base to egg yolk to provide a caustic yolk having a pH of 8±0.25;
(b) adding from 0.0225 to 0.0275% weight percentage of an enzymatic liquid, based on the amount of caustic yolk, to the caustic yolk; and
(c) holding the resulting mixture at a temperature of from about 43° C. to 54° C. for about 250 to 500 minutes to provide the hydrolyzed egg yolk product.

22. The process of claim 21, wherein the egg yolk is pasteurized.

23. The process of claim 22, wherein pasteurizing the egg yolk comprises heating the egg yolk to a temperature ranging from about 60° C. to 66° C.

24. The process of claim 22, wherein pasteurizing egg yolk comprises heating the egg yolk for 200 to 600 seconds.

25. The process of claim 21, wherein the aqueous solution of a GRAS base is added to the egg yolk to provide a caustic yolk having a pH of 8±0.2.

26. The process of claim 21, wherein the mixture is held at a temperature of from about 46° C. to 52° C.

27. The process of claim 21, wherein the aqueous solution of a GRAS base is an aqueous solution of NaOH or KOH.

28. The process of claim 21, wherein the aqueous solution of a GRAS base is provided at a concentration (w/w %) of about 1% to about 30%,

29. The process of claim 21, wherein the enzymatic liquid comprises an enzyme:water ratio (w/w) of from 1:2 to 1:10.

30. The process of claim 21, wherein the enzymatic liquid is added to the caustic yolk in an amount ranging from 0.023 to 0.027% weight percent, based on the amount of caustic yolk.

31. The process of claim 21, further comprising pasteurizing the hydrolyzed egg yolk product.

32. The process of claim 31, wherein pasteurizing the hydrolyzed egg yolk product comprises heating the hydrolyzed egg yolk product to a temperature of from about 66° C. to about 72° C.

33. The process of claim 31, wherein pasteurizing the hydrolyzed egg yolk product comprises maintaining the hydrolyzed egg yolk product at an elevated temperature for 150 to 500 seconds.

34. The process of claim 31, wherein pasteurizing the hydrolyzed egg yolk product comprises heating the hydrolyzed egg yolk product to a temperature of from about 69° C. to about 70.5° C. for 330 to 400 seconds.

35. The process of claim 21, wherein the hydrolyzed egg yolk product comprises from about 6.5% to about 12% (w/w) of oleic acid.

36. The process of claim 21, wherein a pH of the hydrolyzed egg yolk product, measured at from 120° F. to 124° F., is from 6.3 to 7.0.

37. The process of claim 21, further comprising spray drying the hydrolyzed egg yolk product.

38. A modified egg yolk powder comprising the spray dried hydrolyzed egg yolk product of claim 35.

39. The process of claim 21, wherein the hydrolyzed liquid egg yolk product exhibits a viscosity of 3800±250 cP.

40. The method of claim 21, wherein the enzymatic liquid comprises phospholipase A2.
